(19) United States
(12) Patent Application Publication
(10) Pub. No.: US 2020/0011009 A1
(43) Pub. Date: Jan. 9, 2020

(54) SHEET, SHEET MANUFACTURING APPARATUS, AND SHEET MANUFACTURING METHOD

(71) Applicant: SEIKO EPSON CORPORATION, Tokyo (JP)

(72) Inventors: Akira ARAI, Suwa-gun, Shimosuwa-machi, Nagano (JP); Kaneo YODA, Okaya, Nagano (JP); Shunichi SEKI, Suwa, Nagano (JP); Yoshihiro UENO, Shiojiri, Nagano (JP); Kazuhiro ICHIKAWA, Okaya, Nagano (JP); Shinichi KATO, Matsumoto, Nagano (JP); Hidehiro TAKANO, Matsumoto, Nagano (JP)

(21) Appl. No.: 16/491,592

(22) PCT Filed: Jan. 30, 2018
(86) PCT No.: PCT/JP2018/002960

§ 371 Date: Sep. 6, 2019

(30) Foreign Application Priority Data
Mar. 8, 2017 (JP) 2017-043556

(51) Int. Cl. D21B 1/06; B27N 3/04; D04H 1/60; D04H 1/732

(52) U.S. Cl. CPC D21B 1/06; D04H 1/732; D04H 1/60; B27N 3/04

(57) ABSTRACT

A sheet is configured to have a first complex having a fiber and a fiber aggregation inhibitor integrally, a second complex having a fiber and a fiber aggregation inhibitor integrally, and a binding material which combines the first complex and the second complex and contains a resin.

### CROSS-REFERENCE TO RELATED APPLICATIONS

This application is a U.S. National stage application of International Patent Application No. PCT/JP2018/002960, filed on Jan. 30, 2018, which claims priority under 35 U.S.C. § 119(a) to Japanese Patent Application No. 2017-043556, filed in Japan on Mar. 8, 2017. The entire disclosure of Japanese Patent Application No. 2017-043556 is hereby incorporated herein by reference.

### TECHNICAL FIELD

The present invention relates to a sheet, a sheet manufacturing apparatus, and a sheet manufacturing method.

### BACKGROUND ART

In the related art, in a sheet manufacturing apparatus, a so-called wet system is adopted, in which a raw material containing a fiber is put into water, disaggregated mainly by a mechanical action, and regrind. Such wet system sheet manufacturing apparatus requires a large amount of water, and the apparatus becomes larger. Furthermore, maintenance of a water treatment facility takes time and energy for a drying process increases.

A dry sheet manufacturing apparatus that does not use water as much as possible is proposed for reducing the apparatus size and saving the energy. For example, Japanese Unexamined Patent Application Publication No. 2015-92032 describes a sheet manufacturing apparatus that defibrates a paper piece into fibers, mixes the defibrated fibers with a complex containing a resin and an aggregation inhibitor, integrally, and binds the fiber and the complex in a dry fibrillation machine.

However, since the defibrated fiber is susceptible to frictional electrification, fuzzing, and crimp, aggregation may be promoted to result in clumps. Therefore, in the sheet manufactured by the above-described sheet manufacturing apparatus, a portion where a density of fibers is deviated may occur, which may affect a quality of the sheet.

### SUMMARY

One of objects in accordance with some aspects of the present invention is to provide a sheet with inhibited fiber aggregation and high uniformity of fiber distribution. In addition, one of objects in accordance with some aspects of the present invention is to provide a sheet manufacturing apparatus capable of manufacturing a sheet with inhibited fiber aggregation and high uniformity of fiber distribution. In addition, one of objects in accordance with some aspects of the present invention is to provide a sheet manufacturing method capable of manufacturing a sheet with inhibited fiber aggregation and high uniformity of fiber distribution.

An aspect of a sheet according to the present invention is configured to have a first complex having a fiber and a fiber aggregation inhibitor integrally, a second complex having a fiber and a fiber aggregation inhibitor integrally, and a binding material which combines the first complex and the second complex and contains a resin.

In such a sheet, fiber aggregation is suppressed, and the uniformity of the distribution of fibers is high compared to a case where the fiber and the fiber aggregation inhibitor are not integrated.

The sheet according to the present invention has a first surface and a second surface opposite to the first surface, and the fiber aggregation inhibitor is included between the first surface and the second surface.

In such a sheet, in the sheet, fiber aggregation within the sheet is suppressed and the uniformity of the distribution of fibers is high.

The sheet according to the present invention has a first surface and a second surface opposite to the first surface, the fiber aggregation inhibitor is included between the first surface and the second surface, and an abundance ratio of the fiber aggregation inhibitor is greater between the first surface and the second surface than at least one of the first surface and the second surface.

In such a sheet, the aggregation of the fibers is suppressed inside and the uniformity of the distribution of the fibers is high.

In the sheet according to the present invention, the fiber aggregation inhibitor contains at least one of calcium carbonate, clay, titanium dioxide, white carbon, kaolin, and talc.

In such a sheet, the fiber aggregation inhibitor can suppress the fiber aggregation.

In the sheet according to the present invention, a content of the fiber aggregation inhibitor is 5 parts or more and less than 25 parts relative to 100 parts of the fiber.

In the sheet according to the present embodiment, the fiber aggregation is suppressed more reliably and the uniformity of the distribution of the fibers is high.

In the sheet according to the present invention, the content of the fiber aggregation inhibitor is 10 parts or more and less than 20 parts relative to 100 parts of the fiber.

In the sheet according to the present embodiment, further reliably, the fiber aggregation is suppressed and the uniformity of the distribution of the fibers is high.

An aspect of a sheet manufacturing apparatus according to the present invention includes a defibration unit that defibrates a raw material containing a fiber, a first mixer that mixes a defibrated substance defibrated by the defibration unit with a fiber aggregation inhibitor to form a complex containing the defibrated substance and the fiber aggregation inhibitor integrally, a second mixer that mixes the complex and a binding material containing a resin, an accumulation unit that accumulates a mixture containing the complex and the binding material, and a sheet former that forms a sheet by heating and pressing an accumulated object accumulated by the accumulation unit.

In such a sheet manufacturing apparatus, a sheet with inhibited fiber aggregation and high uniformity of fiber distribution can be manufactured.

In the sheet manufacturing apparatus according to the present invention includes a rough crushing unit that cuts the raw material into small pieces and a supply unit that supplies the fiber aggregation inhibitor to the rough crushing unit, in which the defibration unit may defibrate the small pieces.

In such a sheet manufacturing apparatus, in a pipe connecting the defibration unit and a part to which the defibrated substance is conveyed next, it is possible to suppress the aggregation of fibers and clogging of the pipe.

In the sheet manufacturing apparatus according to the present invention includes a classifying unit that separates the defibrated substance and the fiber aggregation inhibitor and a supply unit that supplies the fiber aggregation inhibitor separated by the classifying unit to the first mixer, in which the raw material may be used paper.

In such a sheet manufacturing apparatus, the fiber aggregation inhibitor included in the used paper can be reused.

An aspect of a sheet manufacturing method according to the present invention includes defibrating a raw material containing a fiber, mixing a defibrated substance which is defibrated with a fiber aggregation inhibitor to form a complex containing the defibrated substance and the fiber aggregation inhibitor integrally, mixing the complex and a binding material containing a resin, accumulating a mixture containing the complex and the binding material, and forming a sheet by heating and pressing an accumulated object which is accumulated.

In such a sheet manufacturing method, a sheet with inhibited fiber aggregation and high uniformity of fiber distribution can be manufactured.

### BRIEF DESCRIPTION OF DRAWINGS

FIG. 1 is a cross-sectional view schematically illustrating a complex of a sheet according to the present embodiment.

FIG. 2 is a view schematically illustrating a sheet manufacturing apparatus according to the present embodiment.

FIG. 3 is a view schematically illustrating a sheet manufacturing apparatus according to a first modification example of the present embodiment.

FIG. 4 is a view schematically illustrating a sheet manufacturing apparatus according to a second modification example of the present embodiment.

FIG. 5 is a view schematically illustrating a fiber aggregation inhibitor separation unit of the sheet manufacturing apparatus according to the second modification example of the present embodiment.

FIG. 6 is a flowchart for illustrating a sheet manufacturing method of the present embodiment.

FIG. 7 is a table illustrating experimental results.

FIG. 8 is a SEM image of a sheet.

FIG. 9 is the SEM image of the sheet.

FIG. 10 is the SEM image of the sheet.

FIG. 11 is the SEM image of the sheet.

### DESCRIPTION OF EMBODIMENTS

Hereinafter, preferable embodiments of the present invention will be described in detail with reference to the drawings. The embodiments described below do not unduly limit the contents of the present invention described in the claims. In addition, the entire configuration to be described below is not an essential configurational requirement of the present invention.

### 1. Sheet

Firstly, a sheet according to the present embodiment will be described. The sheet according to the present embodiment is a sheet in which fibers are bonded by a binding material. Specifically, in the sheet according to the present embodiment, the fibers are integrated with a fiber aggregation inhibitor to form a complex, and the complexes in which the fibers and the fiber aggregation inhibitor are integrated include a resin are bounded with the binding material containing a resin. The sheet according to the present embodiment is, for example, a single layer.

### 1.1. Fiber

The sheet according to the present embodiment contains fibers. It does not specifically limit as a fiber (fiber material) contained in the sheet according to the present embodiment, and a wide range of a fiber material can be used. Examples of the fiber include natural fibers (animal fibers, plant fibers), chemical fibers (organic fibers, inorganic fibers, organic-inorganic complex fibers) and the like, and more specifically, cellulose, fibers formed of cellulose, silk, wool, cotton, cannabis, kenaf, flax, ramie, hemp, manila hemp, sisal hemp, conifers, hardwoods, or the like, or fibers formed of rayon, lyocell, cupra, vinylon, acrylic, nylon, aramid, polyester, polyethylene, polypropylene, polyurethane, polyimide, carbon, glass, metal fibers, and these may be used alone, may be used as appropriate mixed, and may be used as regenerated fibers subjected to purification and the like. The fibers may be dried, or may contain or be impregnated with a liquid such as water or an organic solvent. In addition, various surface treatments may be performed. Further, the material of the fiber may be a pure substance, or may be a material containing a plurality of components such as impurities, additives and other components.

The fibers contained in the sheet according to the present embodiment are basically in a form of a string or a ribbon, may be an independent fiber, and a plurality of fibers are entangled with each other, and may be a string or a flat string as a whole. In addition, as the fiber material, a cotton-like form may be formed. A fiber structure may be a so-called single fiber made of one kind of material, or the material may change continuously or stepwise from the central part to the outer peripheral part. An example of a material whose material changes stepwise from the center to the outer periphery of the fiber includes fibers having a so-called core-sheath structure. Furthermore, the fibers may be curvilinear or crimped. In addition, the shape of the cross section of the fiber is not particularly limited, and may be circular, elliptical, polygonal, or a combination thereof. It may also be fibrillated fibers.

The fibers contained in the sheet according to the present embodiment have an average diameter (when the cross section is not a circle, the diameter of the circle (equivalent circle diameter) when assuming a circle having an area equal to the largest one among the lengths in the direction perpendicular to the longitudinal direction or the area of the cross section) of the circle when assuming a circle having an area equal to the area of the cross section is 1 μm to 1000 μm, preferably 2 μm to 500 μm, and more preferably 3 μm to 200 μm on average.

The length of the fibers contained in the sheet according to the present embodiment is not particularly limited, but it is one independent fiber, and the length of the fibers along a longitudinal direction is 1 μm to 5 mm, preferably 2 μm to 3 mm, and more preferably 3 μm to 2 mm. When the length of the fiber is short, the strength of the sheet may be insufficient. However, in the above range, a sheet having sufficient strength can be obtained. The length of the fiber along the longitudinal direction may be a distance (length of the fiber) between the two ends when one of the independent fibers is pulled so as not to break as necessary and placed in a substantially linear state in that state. In addition, the average length of the fibers is 20 μm to 3600 μm, preferably 200 μm to 2700 μm, and more preferably 300 μm to 2300 μm, as a length-weighted average fiber length (Lw). Furthermore, the lengths of the fibers may have variations (distributions), and in a distribution obtained by n number of 100 or more for one independent fiber length, when assuming a normal distribution, a may be 1 μm to 1100 μm, preferably 1 μm to 900 μm, and more preferably 1 μm to 600 μm.

The thickness and length of the fibers can be measured by various optical microscopes, scanning electron microscopes (SEM), transmission electron microscopes (TEM), fiber testers and the like. In the case of microscopic observation, by appropriately pretreating the observation sample as necessary, it is possible to perform cross-sectional observation and observation in a tensioned state so as not to break both ends of one independent fiber as necessary.

The term “cotton-like” refers to a state in which one long fiber or a plurality of fibers are entangled or partially in contact with each other to have a three-dimensional bulky outer shape. That is, the cotton-like is a three-dimensional shape formed by entanglement or partial contact of fibers, and means a state in which a gas is included in the shape. Furthermore, the word “cotton-like” is used regardless of whether a plurality of fibers are bound.

### 1.2. Fiber Aggregation Inhibitor

The sheet according to the present embodiment includes a fiber aggregation inhibitor. The fiber aggregation inhibitor has a function of making it difficult to aggregate fibers when the fiber aggregation inhibitor is blended with fibers as compared to when it is not blended into the fibers. Examples of the fiber aggregation inhibitor include fine particles made of an inorganic substance, and by arranging this on the surface of the fiber, it is possible to obtain a very excellent aggregation suppressing effect. The term “aggregation” refers to a state where objects of the same or different types are in physical contact with each other by electrostatic force or van der Waals force.

The fiber aggregation inhibitor includes, for example, at least one of calcium carbonate, clay, titanium dioxide, white carbon, kaolin and talc. The fiber aggregation inhibitor is preferably calcium carbonate. The calcium carbonate used as a fiber aggregation inhibitor may be ground calcium carbonate (GCC) or precipitated calcium carbonate (PCC).

The average particle size (number average particle size) of the particles of the fiber aggregation inhibitor is not particularly limited, but is, for example, 0.001 μm to 30 μm, preferably 0.003 μm to 1 μm, and more preferably 0.008 μm to 0.6 μm. The average particle size of the particles of the fiber aggregation inhibitor is, for example, smaller than the average length of the fibers. The particles of the aggregation inhibitor are generally in the form of primary particles because they are close to the so-called category of nanoparticles and the particle diameter is small. However, multiple primary particles are combined to form high-order particles. If the particle diameter of the primary particle of the fiber aggregation inhibitor is within the above range, the surface of the fiber can be coated well, and a sufficient aggregation suppression effect can be imparted.

The sheet according to the present embodiment contains a fiber aggregation inhibitor inside. The fiber aggregation inhibitor may be attached to a surface of the sheet. In the sheet according to the present embodiment, the abundance ratio of the fiber aggregation inhibitor is larger at the inside than at least one of the both surfaces. That is, the sheet has a first surface and a second surface opposite to the first surface, and an abundance ratio of the fiber aggregation inhibitor inside the sheet is greater than at least one of the abundance ratio of the fiber aggregation inhibitor on the first surface of the sheet and the abundance ratio of the fiber aggregation inhibitor on the second surface of the sheet. The reason why the abundance ratio of the fiber aggregation inhibitor is larger in the inside than at least one of the both surfaces will be described in “2. Sheet Manufacturing Apparatus” described later.

In addition, “the abundance ratio of the fiber aggregation inhibitor of the surface” is the number of fiber aggregation inhibitors per unit area on the surface of the sheet. In addition, “abundance ratio of the fiber aggregation inhibitor inside” means that the outermost surface (for example, the first surface or the second surface) of the sheet is cut and removed by scraper or sandpaper to expose a new surface, The number of fiber aggregation inhibitors per unit area on the new surface. Thus, the “inside” is a portion other than the outermost surface, for example, a portion between the first surface and the second surface. The number of fiber aggregation inhibitors per unit area can be measured by SEM.

The content of the fiber aggregation inhibitor is, for example, 5 parts or more and less than 25 parts with respect to 100 parts of fibers, and preferably 10 parts or more and less than 20 parts. Therefore, in the sheet according to the present embodiment, the fiber aggregation is suppressed more reliably, and the uniformity of the distribution of the fibers is high. The content of the fiber aggregation inhibitor relative to 100 parts of fibers can be determined, for example, by measuring the mass before burning the sheet and the mass after burning the sheet to evaporate the fibers. In this case, the mass before burning the sheet can be regarded as the total mass of the fiber and the fiber aggregation inhibitor, and the mass after burning the sheet can be regarded as the mass of the fiber aggregation inhibitor.

### 1.3. Complex

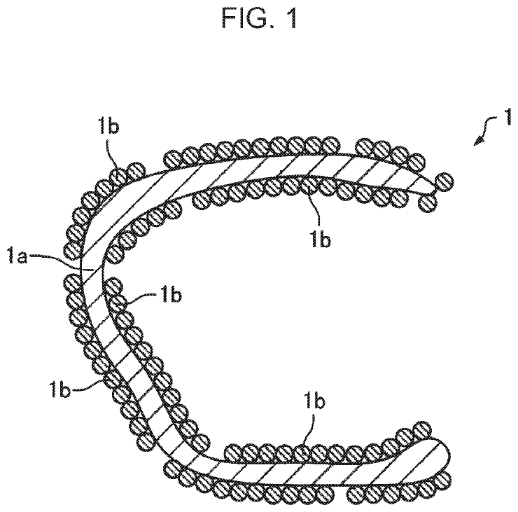

The sheet according to the present embodiment includes a complex. Here, FIG. 1 is a cross-sectional view schematically illustrating a complex 1 of a sheet according to the present embodiment. A complex 1 integrally includes a fiber 1a and a fiber aggregation inhibitor 1b, as illustrated in FIG. 1. In the illustrated example, the fiber 1a has a curvilinear shape, but may have a linear shape. In the illustrated example, all of the fiber aggregation inhibitor 1b adheres to the fiber 1a, for example, the fiber aggregation inhibitor 1b which is not attached to the fiber 1a does not exist.

The “having a fiber and a fiber aggregation inhibitor integrally” means a state where the fiber aggregation inhibitor is in close contact with the surface of the fiber by van der Waals force, electrostatic force, adhesive force or the like. When the fiber aggregation inhibitor is disposed on the surface of the fibers, the fiber aggregation inhibitor is present between the fibers and the fibers different from the fibers, and the fiber aggregation can be suppressed.

A proportion of fiber aggregation inhibitor is covered relative to the surface of the fiber (the ratio of the area of the surface of the fiber in contact with the fiber aggregation inhibitor to the area of the entire surface of the fiber) is, for example, 20% to 100%, preferably 50% to 100%, and more preferably 80% to 100%. The proportion can also be measured by various electron microscopes.

The complex is formed by mixing the fiber and the fiber aggregation inhibitor. Examples of the method of mixing the fiber and the fiber aggregation inhibitor include mixing by a rotating drum, mixing by an air flow generated by a blower, and mixing with a mixer. In particular, by using a plurality of different mixing methods (for example, by combining the mixing with a rotating drum and the mixing by an air flow generated by a blower), it is possible to more reliably form a complex having a fiber and a fiber aggregation inhibitor, integrally. By such mixing, the fiber aggregation inhibitor may be disposed in a state where at least a portion thereof bites into the surface of the fiber, or in this case, the fiber aggregation inhibitor is less likely to fall off from the fiber. It is possible to achieve the aggregation suppression effect more stably.

The complex can be identified using energy dispersive X-ray spectroscopy SEM (SEM-EDX). Specifically, by performing micro area spots of the SEM image with an energy dispersive X-ray spectroscopy (EDX) and performing elemental analysis of the powder adhering to the fiber, the presence of a complex having a fiber and a fiber aggregation inhibitor can be confirmed, for example. The EDX is a method of performing elemental analysis and composition analysis by detecting specific X-rays generated by electron beam irradiation and performing spectroscopy with energy. Since the energy of the specific X-ray is element-specific, the elements constituting the sample can be identified, and the information on the composition can be obtained from the intensity. The complex can also be confirmed using TEM-EDX in which the EDX is attached to TEM.

The complex may be confirmed by immersing the sheet in a high-temperature solvent (for example, xylene) to evaporate the binding material and adhering the fiber aggregation inhibitor to the remaining fibers.

### 1.4. Binding Material

The sheet according to the present embodiment includes a binding material. The complexes are bound by the binding material. “The complexes are bonded by the binding material” means that the binding material is disposed between the complex and the complex, and the complex and the complex are less likely to be separated via the binding material. The binding material contains a resin. Specifically, the binding material is formed of resin. The resin may be a fibrous resin or a powdery resin. The resin is, for example, hydrophobic.

The resin used as the binding material may be a thermoplastic resin. When the thermoplastic resin is heated to a temperature above the glass transition temperature (softening point) or the melting point (in the case of a crystalline polymer), the resin softens or melts, and the temperature drops to solidify. The resin softens and contacts the complex so as to be entangled, and by solidification of the resin, the fiber and the complex can be bound (bonded) to each other. Examples of a thermoplastic resin include an AS resin, an ABS resin, polypropylene, polyethylene, polyvinyl chloride, polystyrene, acrylic resin, polyester resin, polyethylene terephthalate, polyphenylene ether, polybutylene terephthalate, nylon, polyamide, polycarbonate, polyacetal, polyphenylene sulfide, and polyetheretherketone. The resins above may be used individually or in a proper combination thereof.

The resin used as the binding material may be a thermosetting resin. The thermosetting resin may be heated to a temperature equal to or higher than the softening point, or may be bonded to the complexes each other even if heated to a curing temperature (temperature causing a curing reaction). Examples of a thermosetting resin include a phenol resin, an epoxy resin, a melamine resin, a urea resin, unsaturated polyester resin, an alkyd resin, a polyurethane, and a thermosetting polyimide resin. The resins above may be used individually or in a proper combination thereof.

The sheet according to the present embodiment may contain other components in addition to the fiber, the fiber aggregation inhibitor, and the binding material described above. Examples of other components include coloring agents, organic solvents, surfactants, mildew-proofing agents, preservatives, antioxidants, ultraviolet light absorbers, oxygen absorbers and the like.

The sheet according to the present embodiment has, for example, the following features.

In the sheet according to the present embodiment, the complexes which have a fiber and a fiber aggregation inhibitor integrally are bonded with the binding material containing resin. Therefore, in the sheet according to the present embodiment, the aggregation of the fibers is suppressed and the uniformity of the distribution of the fibers is high, as compared to the case where the fibers and the fiber aggregation inhibitor are not integrated. As described above, in the sheet according to the present embodiment, the aggregation of the fibers is suppressed, and therefore, in the sheet manufacturing apparatus for manufacturing the sheet according to the present embodiment, the apparatus failure caused by clogged aggregated fibers (supply defects and discharge defects) can be suppressed, and the reliability of the sheet manufacturing apparatus can be increased.

Furthermore, in the sheet according to the present embodiment, since the uniformity of the distribution of the fibers is high, it is possible to improve the isotropy of the sheet by, for example, suppressing the deviation of mechanical characteristics (for example, modulus of elasticity, coefficient of expansion, elongation in water) in the in-plane direction of the sheet (for example, in a machine direction (MD) and a cross direction (CD)). Therefore, in the sheet according to the present embodiment, curling and cockling at the time of printing can be suppressed, and high quality can be provided.

Furthermore, the sheet according to the present embodiment includes a properly crimped fiber, and has a structure in which a properly crimped fiber is randomly intertwined (see “5. Experimental example” for details). Therefore, in the sheet according to the present embodiment, the isotropy of the sheet in the in-plane direction can be further improved. For example, when the fiber is crimped appropriately, even if the fiber contains water and expands, the expansion is dispersed in the in-plane direction, and expansion in one direction can be suppressed.

Furthermore, in the sheet according to the present embodiment, since the fiber aggregation is suppressed and the uniformity of the distribution of the fibers is high, the sheet is bulky and has many voids, and the deviation of the voids is further suppressed. Furthermore, since the sheet according to the present embodiment has a structure in which appropriately crimped fibers are randomly intertwined in three dimensions, the sheet is more bulky and has many voids. Therefore, the sheet according to the present embodiment can improve the print quality when printed by the ink jet printer. Furthermore, the sheet according to the present embodiment can improve the ink absorption amount and the ink absorption speed when printed by the ink jet printer. Thereby, the sheet according to the present embodiment can make distortion due to swelling and humidity uniform on the front and back of the sheet, and can suppress curling and cockling.

Furthermore, the sheet according to the present embodiment includes a binding material containing a resin. Therefore, the curling and the cockling can be suppressed without lowering the cohesion of the complex due to the penetration of the ink. For example, a sheet manufactured by a wet method, the penetration of the ink may reduce the bonding strength of the hydrogen bond in some cases.

Furthermore, in the sheet according to the present embodiment, the selective absorption in the vertical direction (thickness direction) of the ink is achieved by the interaction between shortening of the fiber length by the shearing action of a defibration unit to be described later and crimping. Since the acceleration is achieved, it is possible to obtain high resolution quality with less bleeding in the planar direction (in-plane direction) and bleeding.

In the sheet according to the present embodiment, the fiber aggregation inhibitor is contained inside, and the abundance ratio of the fiber aggregation inhibitor is greater in the inside than at least one of the both surfaces. Therefore, in the sheet according to the present embodiment, the fiber aggregation is suppressed inside, and the uniformity of the distribution of the fibers is high.

In the sheet according to the present embodiment, the fiber aggregation inhibitor includes at least one of calcium carbonate, clay, titanium dioxide, white carbon, kaolin, and talc. Therefore, in the sheet according to the present embodiment, the fiber aggregation inhibitor can suppress the aggregation of fibers.

In the sheet according to the present embodiment, the content of the fiber aggregation inhibitor is 5 parts or more and less than 25 parts and preferably 10 parts or more and less than 20 parts relative to 100 parts of fibers. Therefore, in the sheet according to the present embodiment, the fiber aggregation is suppressed more reliably and the uniformity of the distribution of the fibers is high.

The sheet according to the present invention mainly refers to a sheet formed of a fiber as a raw material. However, the sheet according to the present invention is not limited to the sheet-like one, and may have a board-like shape, a web-like shape, or an uneven shape. The sheet according to the present invention can be classified into paper and non-woven fabric. Examples of the paper include an aspect in which pulp or used paper is used as a raw material and formed into a sheet, and includes recording paper for writing and printing, wallpaper, or wrapping paper, colored paper, drawing paper, Kent paper, and the like. The non-woven fabric is thicker or lower in strength than paper, and includes general non-woven fabric, fiber board, tissue paper, kitchen paper, cleaner, filter, liquid absorber, sound absorber, shock absorber, mat and the like.

### 2. Sheet Manufacturing Apparatus

### 2.1. Configuration

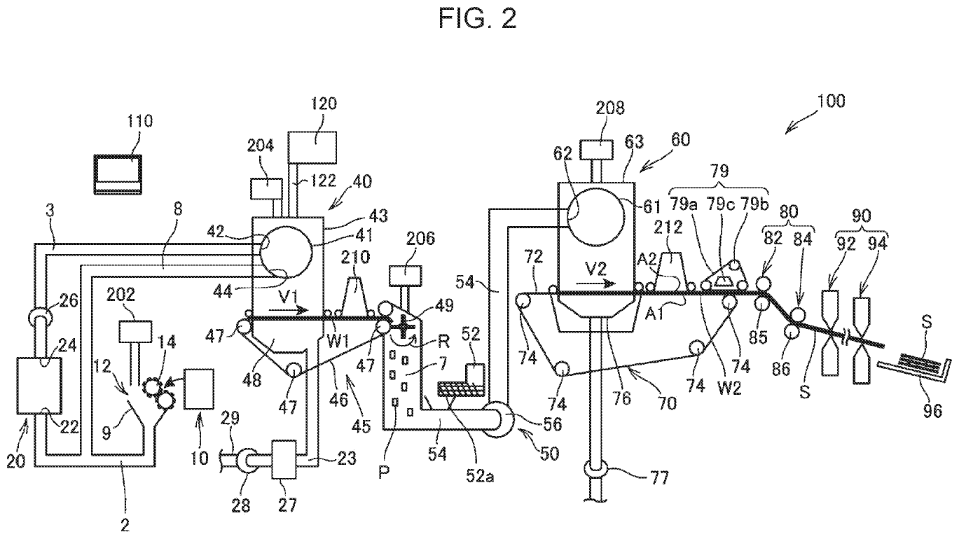

Next, a sheet manufacturing apparatus according to the present embodiment will be described with reference to the drawings. FIG. 2 is a view schematically illustrating a sheet manufacturing apparatus 100 according to the present embodiment. The sheet manufacturing apparatus 100 is an apparatus for manufacturing a sheet according to the present embodiment.

For example, the sheet manufacturing apparatus 100 described in the embodiment is an apparatus that is suitable for defibrating used waste paper such as confidential paper as a raw material in a dry method such that the paper is fiberized and, then, manufacturing new paper through pressurization, heating, and cutting. The fiberized raw material is mixed with various additives, and thereby bond strength or a whiteness level of a paper product may improve or a function of coloring, scenting, or flame resisting may be added, depending on a use. In addition, forming is performed by controlling density, a thickness, and a shape of paper, and thereby it is possible to manufacture paper having various thicknesses or sizes, depending on a use such as office paper having an A4 or A3 size or business card paper.

The sheet manufacturing apparatus 100 includes a supply unit 10, a rough crushing unit 12, a defibration unit 20, a sorting unit 40, a first web former 45, a rotary body 49, a mixer 50, an accumulation unit 60, a second web former 70, a conveying unit 79, a sheet former 80, a cutter 90, and a controller 110.

In addition, the sheet manufacturing apparatus 100 includes humidifying units 202, 204, 206, 208, 210, and 212 for the purpose of humidifying the raw material and/or a space through which the raw material moves.

The humidifying units 202, 204, 206, 208, 210, and 212 have any specific configurations, and examples thereof include a steam type, a vaporization type, a hot air vaporization type, an ultrasound type, or the like.

In the embodiment, the humidifying units 202, 204, 206, and 208 are each configured of a vaporization-type or hot air vaporization-type humidifier. In other words, each of the humidifying units 202, 204, 206, and 208 has a filter (not illustrated) into which water infiltrates and causes air to pass through the filter, thereby supplying humidified air having high humidity. In addition, the humidifying units 202, 204, 206, and 208 may include heaters (not illustrated) that effectively increase the humidity of the humidified air.

In addition, in the embodiment, the humidifying unit 210 and the humidifying unit 212 are each configured of an ultrasound type humidifier. In other words, each of the humidifying units 210 and 212 has a vibrating unit (not illustrated), which atomizes water, and supplies mist generated by the vibrating unit.

The supply unit 10 supplies the raw material to the rough crushing unit 12. The raw material from which the sheet manufacturing apparatus 100 manufactures a sheet may contain a fiber and examples of the raw material include a paper, a pulp, a pulp sheet, a cloth containing a nonwoven fabric, or textiles or the like. In the present embodiment, a configuration in which the sheet manufacturing apparatus 100 uses the used paper as a raw material is exemplified. The supply unit 10 can be configured to include, for example, a stacker that accumulates and accumulates the used paper pieces, and an automatic feeding device that feeds the used paper from the stacker to the rough crushing unit 12.

The rough crushing unit 12 has rough crushing blades 14 that cuts (roughly crushes) the raw material supplied by the supply unit 10 into rough-crushed pieces. The rough crushing blades 14 cut the raw material in a gas atmosphere such as in the atmosphere (in the air). For example, the rough crushing unit 12 includes a pair of rough crushing blades 14, which pinches and cuts the raw material, and a drive unit, which rotates the rough crushing blades 14, and the rough crushing unit can have the same configuration as that of a so-called shredder. The rough-crushed pieces may have any shape or size as long as the shape or size is suitable for a defibrating process in the defibration unit 20. For example, the rough crushing unit 12 cuts the raw material into paper pieces having a size equal to or smaller than 1 square centimeter to several square centimeters.

The rough crushing unit 12 has a chute (hopper) 9 that receives the rough-crushed pieces which are cut by the rough crushing blades 14 and fall down. For example, the chute 9 has a tapered shape having a width that is gradually decreased in a direction (proceeding direction) in which the rough-crushed pieces flow. Therefore, the chute 9 is capable of receiving a large amount of rough-crushed pieces. A pipe 2 that communicates with the defibration unit 20 is connected to the chute 9, and the pipe 2 forms a conveying channel for conveying the raw material (rough-crushed pieces) cut by the rough crushing blades 14 to the defibration unit 20. The rough-crushed pieces are gathered by the chute 9 and are conveyed (conveyed) to the defibration unit 20 through the pipe 2. The rough-crushed pieces are conveyed in the pipe 2 toward the defibration unit 20, for example, by an air flow generated by a blower (not illustrated).

The humidifying unit 202 supplies humidified air to the chute 9 or the vicinity of the chute 9 included in the rough crushing unit 12. Consequently, it is possible to suppress a phenomenon in which rough-crushed materials cut by the rough crushing blades 14 are attached to an inner surface of the chute 9 or the pipe 2 due to static electricity. In addition, the rough-crushed materials cut by the rough crushing blades 14 are conveyed together with humidified air (having high humidity) to the defibration unit 20, and thus it is also possible to expect an effect of suppressing attachment of a defibrated substance to an inside of the defibration unit 20. In addition, the humidifying unit 202 may be configured to supply the humidified air to the rough crushing blades 14 so as to remove electricity from the raw material that is supplied by the supply unit 10.

In addition, an ionizer together with the humidifying unit 202 may remove electricity.

The defibration unit 20 defibrates rough crushed materials cut by the rough crushing unit 12. More specifically, the defibration unit 20 performs a defibrating process on the raw material (rough crushed pieces) cut by the rough crushing unit 12 and generates the defibrated substance.

Here, “to defibrate” means to unravel fibers one by one from the raw material (defibration target object) in which a plurality of fibers are bound. The defibration unit 20 also has a function of separating a substance such as a resin grain, ink, toner, or a bleeding preventive agent, which is attached to the raw material, from the fiber.

A substance having passed through the defibration unit 20 is referred to as the “defibrated substance”. The “defibrated substance” includes a resin (resin for binding a plurality of fibers to each other) grain, a coloring agent such as ink or toner, or an additive such as a bleeding preventive agent or a paper strengthening agent, which is separated from the fiber when the fiber is unraveled, in addition to an unraveled defibrated fiber, in some cases. The unraveled defibrated substance which has a string shape or a ribbon shape. The unraveled defibrated substance may be present in a state in which the substance is not intertwined with another unraveled fiber (an independent state) or may be present in a state in which the substance is intertwined with another unraveled defibrated substance into a blocking shape (a state of forming a so-called “clump”).

The defibration unit 20 performs dry defibration. Here, defibration performed through a process of defibration not in a liquid but in a gas such as in the atmosphere (in the air) is referred to as the dry defibration. In the embodiment, the defibration unit 20 is configured of an impeller mill. Specifically, the defibration unit 20 includes a rotor (not illustrated) that rotates at a high speed and a liner (not illustrated) that is positioned along an outer circumference of the roller. The rough-crushed pieces that have been cut by the rough crushing unit 12 are sandwiched between the rotor and the liner of the defibration unit 20 so as to be defibrated. The defibration unit 20 generates an air flow due to the rotation of the rotor. The air flow enables the defibration unit 20 to suction the rough-crushed pieces which are the raw material from the pipe 2 and convey the defibrated substance to a discharge port 24. The defibrated substance is delivered to a pipe 3 from the discharge port 24 and is conveyed to the sorting unit 40 via the pipe 3.

In this manner, the defibrated substance that is generated in the defibration unit 20 is conveyed to the sorting unit 40 from the defibration unit 20 due to the air flow that is generated by the defibration unit 20. Further, in the embodiment, the sheet manufacturing apparatus 100 includes a defibration unit blower 26 that is an air flow generating device, and the defibrated substance is conveyed to the sorting unit 40 due to the air flow generated by the defibration unit blower 26. The defibration unit blower 26 is attached to the pipe 3, suctions air together with the defibrated substance from the defibration unit 20, and performs blowing to the sorting unit 40.

The sorting unit 40 is provided with an introduction port 42 into which the defibrated substance defibrated by the defibration unit 20 flows along with the air flow from the pipe 3. The sorting unit 40 sorts the defibrated substance introduced to the introduction port 42 depending on a length of fiber. To be more specific, the sorting unit 40 sorts a defibrated substance having a size equal to or smaller than a predetermined size into a first sorted substance, and a defibrated substance that is larger than the first sorted substance into a second sorted substance, of defibrated substances defibrated by the defibration unit 20. The first sorted substance includes a fiber, a grain, or the like, and a second sorted substance includes a long fiber, an incompletely defibrated piece (rough-crushed piece that is not sufficiently defibrated), a clump formed by clumping or entwining the defibrated fibers, or the like.

In the embodiment, the sorting unit 40 has a drum portion (sieve portion) 41 and a housing portion (cover portion) 43 that accommodates the drum portion 41.

The drum portion 41 is a cylinder sieve that is rotatably driven by a motor. The drum portion 41 has a net (a filter or a screen) and functions as a sieve (sieve). The drum portion 41 sorts into the first sorted substance smaller than a size of a mesh opening (opening) of the net and the second sorted substance larger than the mesh opening of the net, by meshes of the net. As the net of the drum portion 41, a wire mesh, expanded metal obtained by expanding a metal plate provided with cuts, or punched metal provided with holes formed in a metal plate by a press machine can be used.

The defibrated substance introduced into the introduction port 42 is delivered along with the air flow into the inside of the drum portion 41, and the first sorted substance falls downward from the mesh of the net of the drum portion 41 due to the rotation of the drum portion 41. The second sorted substance that cannot pass through the mesh of the net of the drum portion 41 flows to be guided to a discharge port 44 and is delivered to a pipe 8 along with the air flow flowing to the drum portion 41 from the introduction port 42.

The pipe 8 connects the inside of the drum portion 41 to the pipe 2. The second sorted substance flowing through the pipe 8 flows to the pipe 2 along with the rough-crushed pieces that have been cut by the rough crushing unit 12 and is guided to an introduction port 22 of the defibration unit 20. Consequently, the second sorted substance returns to the defibration unit 20 and is subjected to a defibrating process.

In addition, the first sorted substances sorted by the drum portion 41 are dispersed in the air through the meshes of the net of the drum portion 41 and drop toward a mesh belt 46 of the first web former 45 that is positioned below the drum portion 41.

The first web former 45 (separation unit) includes the mesh belt 46 (separation belt), a roller 47, and a suction unit (suction mechanism) 48. The mesh belt 46 is an endless belt, is suspended on three rollers 47, and is conveyed along with motion of the rollers 47 in a direction represented by an arrow in the drawing. The mesh belt 46 has a surface configured of a net in which openings having a predetermined size are arranged. Among the first sorted substances dropping from the sorting unit 40, fine particles having a size to the extent that it is possible to pass through the mesh of the net fall downward from the mesh belt 46, and fibers having a size to the extent that it is not possible to pass through the mesh of the net are accumulated on the mesh belt 46 and are conveyed along with the mesh belt 46 in an arrow direction. The fine particles falling from the mesh belt 46 include a relatively small substance or a substance having low density (such as a resin grain, a coloring agent, or an additive) of the defibrated substances and are substances to be removed, which are not used in manufacturing of a sheet S by the sheet manufacturing apparatus 100.

The mesh belt 46 moves at a constant speed V1 at the time of a normal operation of manufacturing the sheet S. Here, the time of the normal operation means a time of an operation excluding times of execution of start control and stop control of the sheet manufacturing apparatus 100 and, to be more specific, indicates while the sheet manufacturing apparatus 100 manufactures the sheet S having a desired quality.

Hence, the defibrated substances subjected to the defibrating process by the defibration unit 20 are sorted into the first sorted substances and the second sorted substances by the sorting unit 40, and the second sorted substances return to the defibration unit 20. In addition, the first web former 45 removes the substance to be removed from the first sorted substances. The rest of the first sorted substances obtained by removing the substance to be removed are materials suitable for manufacturing the sheet S, and the materials are accumulated on the mesh belt 46 so as to form a first web W1.

The suction unit 48 suctions air from below the mesh belt 46. The suction unit 48 is connected to a dust collecting unit 27 via a pipe 23. The dust collecting unit 27 is a filter-type or cyclone-type dust collecting device and separates fine particles from the air flow. A trapping blower 28 is installed downstream of the dust collecting unit 27, and the trapping blower 28 functions as a suction unit for dust collecting that suctions air from the dust collecting unit 27. In addition the air discharged by the trapping blower 28 is discharged out of the sheet manufacturing apparatus 100 via the pipe 29.

In this configuration, air from the suction unit 48 is suctioned by the trapping blower 28 through the dust collecting unit 27. In the suction unit 48, the fine particles that pass through the meshes of the net of the mesh belt 46 are suctioned along with the air and are set to the dust collecting unit 27 through the pipe 23. The dust collecting unit 27 separates the fine particles having passed through the mesh belt 46 from the air flow so as to accumulate the fine particles.

Hence, fibers obtained by removing the substances to be removed from the first sorted substance are accumulated on the mesh belt 46 such that the first web W1 is formed. The trapping blower 28 performs suction, thereby, promoting to form the first web W1 on the mesh belt 46, and the substances to be removed are rapidly removed.

The humidified air generated by the humidifying unit 204 is supplied to a space including the drum portion 41. The first sorted substance is humidified with the humidified air inside the sorting unit 40. Consequently, it is possible to weaken attachment of the first sorted substance to the mesh belt 46 due to an electrostatic force and peel the first sorted substance from the mesh belt 46 easily. Further, it is possible to suppress attachment of the first sorted substance to an inner wall of the rotary body 49 or the housing portion 43 due to the electrostatic force. In addition, the suction unit 48 is capable of suctioning the substance to be removed efficiently.

In the sheet manufacturing apparatus 100, a configuration of sorting and separating the first defibrated substance and the second defibrated substance from each other is not limited to the sorting unit 40 that includes the drum portion 41. For example, a configuration may be employed, in which the defibrated substances subjected to the defibrating process by the defibration unit 20 are classified by a classifier. For example, it is possible to use a cyclone classifier, an elbow jet classifier, or an eddy classifier as the classifier. When the classifiers are used, it is possible to sort and separate the first sorted substance and the second sorted substance from each other. Further, the classifier can realize a configuration of separating and removing the substance to be removed, which includes a relatively small substance or a substance having low density (such as a resin grain, a coloring agent, or an additive) of the defibrated substances. For example, in the configuration, the fine particles contained in the first sorted substance may be removed from the first sorted substance by the classifier. In this case, it is possible to employ a configuration in which the second sorted substance returns to the defibration unit 20, for example, the substances to be removed are collected by the dust collecting unit 27, and the first sorted substance is sent to a pipe 54 without the substances to be removed.

In a conveyance route of the mesh belt 46, the humidifying unit 210 supplies air containing mist to a downstream side of the sorting unit 40. The mist which is fine particles of water generated by the humidifying unit 210 drops toward the first web W1 and supplies moisture to the first web W1. Consequently, it is possible to adjust an amount of moisture contained in the first web W1, and thus it is possible to suppress attachment or the like of a fiber to the mesh belt 46 due to the static electricity.

The sheet manufacturing apparatus 100 includes the rotary body 49 that divides the first web W1 accumulated on the mesh belt 46. The first web W1 is peeled from the mesh belt 46 and is divided by the rotary body 49 at a position at which the mesh belt 46 is bent by the roller 47.

The first web W1 is a soft material having a web shape, which is formed of the accumulated fibers, and the rotary body 49 loosens the fibers of the first web W1 so as to perform a process of proceeding to a state in which it is easy to mix a resin with the fibers by the mixer 50 to be described below.

The rotary body 49 has any configuration; however, in the embodiment, it is possible to have a rotating vane shape by having a plate-shaped vane that rotates. The rotary body 49 is disposed at a position at which the vane comes into contact with the first web W1 peeled from the mesh belt 46. The rotary body 49 rotates (for example, rotates in a direction represented by an arrow R in the drawing), and thereby the vane collides with the first web W1, which is peeled from the mesh belt 46 so as to be conveyed, such that the first web is divided, and a subdivided body P is generated.

It is preferable that the rotary body 49 be installed at a position at which the vane of the rotary body 49 does not collide with the mesh belt 46. For example, it is possible to have a gap of 0.05 mm or larger and 0.5 mm or smaller between a distal end of the vane of the rotary body 49 and the mesh belt 46. In this case, it is possible to divide the first web W1 efficiently without damage to the mesh belt 46 by the rotary body 49.

The subdivided body P divided by the rotary body 49 drops to an inside of a pipe 7 so as to be conveyed (conveyed) to the mixer 50 along with an air flow flowing in the inside of the pipe 7.

In addition, the humidified air generated by the humidifying unit 206 is supplied to a space including the rotary body 49. Consequently, it is possible to suppress a phenomenon in which the fibers are attached to the inside of the pipe 7 or the vane of the rotary body 49 due to static electricity. In addition, air having high humidity is supplied to the mixer 50 through the pipe 7, and thus it is possible to suppress an influence of the static electricity even in the mixer 50.

The mixer 50 communicates with an additive supply unit 52 that supplies a additive including a resin and the pipe 7 and includes the pipe 54, through which an air flow containing the subdivided body P flows, and a mixing blower 56.

The subdivided body P is a fiber obtained by removing the substance to be removed from the first sorted substance having passed through the first sorting unit 40 as described above. The mixer 50 mixes the fiber configuring the subdivided body P and an additive including a resin.

In the mixer 50, the subdivided body P and the resin are conveyed while the mixing blower 56 generates an air flow, and the subdivided body and the additive are mixed in the pipe 54. In addition, the subdivided body P is loosened in a process of flowing inside the pipe 7 and the pipe 54 so as to have a finer fiber shape.

The additive supply unit 52 (resin container) connects to an additive cartridge (not illustrated) that accumulates the additives to supply an additive inside the additive cartridge to the pipe 54. The additive cartridge may be configured to be removable from the additive supply unit 52. In addition, the additive cartridge may be provided with a configuration for replenishing the additive. The additive supply unit 52 temporarily stores an additive formed of fine powders or fine particles inside the additive cartridge. The additive supply unit 52 includes a discharge unit 52a (resin supply unit) that sends the additive once stored to the pipe 54.

The discharge unit 52a includes a feeder (not illustrated) for delivering the additive stored in the additive supply unit 52 to the pipe 54, and a shutter (not illustrated) for opening and closing the pipe channel connecting a feeder and the pipe 54. When the shutter is closed, the conduit or opening connecting the discharge unit 52a and the pipe 54 is blocked, and the supply of the additive from the additive supply unit 52 to the pipe 54 is stopped.

In a state in which the feeder of the discharge unit 52a does not operate, the additive is not supplied to the pipe 54 from the discharge unit 52a; however, in a case or the like where a pressure in the pipe 54 is a negative pressure, there is a possibility that the additive will flow to the pipe 54 even when the feeder of the discharge unit 52a is stopped. The discharge unit 52a is closed, and thereby it is possible to reliably block the flowing of the additive.

The additive that is supplied by the additive supply unit 52 includes a resin for binding a plurality of fibers. The resin included in the additive is a thermoplastic resin or a thermosetting resin, and examples thereof include AS resin, ABS resin, polypropylene, polyethylene, polyvinyl chloride, polystyrene, acrylic resin, polyester resin, polyethylene terephthalate, polyphenylene ether, polybutylene terephthalate, nylon, polyamide, polycarbonate, polyacetal, polyphenylene sulfide, or polyether ether ketone. The resins above may be used individually or in a proper combination thereof. In other words, the additive may contain a single substance, may be a mixture, or may contain a plurality of types of particles that are each configured of a single or a plurality of substances. In addition, the additive may have a fiber shape or a powder shape.

The resin included in the additive is melted by being heated so as to cause a plurality of fibers to be bonded to each other. Hence, in a state in which the resin is mixed with the fibers, and the resin is not heated to a temperature at which the resin is melted, the fibers are not bound to each other.

In addition, an additive that is supplied by the additive supply unit 52 may contain a colorant for coloring the fibers, a clumping inhibitor for inhibiting the fibers from clumping or the resin from clumping, or a flame retardant for retarding progression of burning of fibers or the like according to the types of the sheet to be manufactured, in addition to the resin that causes the fibers to be bound. In addition, an additive that does not contain the colorant may be colorless or have a light color to the extent that the resin looks colorless or may be white.

The subdivided body P dropping through the pipe 7 and the additive that is supplied by the additive supply unit 52 are suctioned to the inside of the pipe 54 due to the air flow generated by the mixing blower 56 and pass through the inside of the mixing blower 56. An action of the air flow generated by the mixing blower 56 and/or a rotary unit such as the vane included in the mixing blower 56 causes the additive and the fiber configured of the subdivided body P to be mixed, and a mixture (mixture of the first sorted substance and the additive) is conveyed to the accumulation unit 60 through the pipe 54.

A mechanism that mixes the first sorted substance and the additive is not particularly limited, and a mechanism that performs agitation by a vane which rotates at a high speed may be employed, or a mechanism of using rotation of a container such as a V-shaped mixer may be employed, and the mechanism may be installed in front or rear of the mixing blower 56.

The accumulation unit 60 accumulates the defibrated substance defibrated by the defibration unit 20. More specifically, the accumulation unit 60 introduces the mixture having passed through the mixer 50 from an introduction port 62 and loosens intertwined defibrated substances (fibers) so as to be dropped while the fibers are dispersed in the air. Further, in a case where the resin of the additive that is supplied from the additive supply unit 52 has a fiber shape, the accumulation unit 60 loosens the intertwined resins. Consequently, the accumulation unit 60 is capable of accumulating the mixture in the second web former 70 with good uniformity.

In the embodiment, the accumulation unit 60 has a drum portion 61 and a housing portion (cover portion) 63 that accommodates the drum portion 61. The drum portion 61 is a cylinder sieve that is rotatably driven by a motor. The drum portion 61 has a net (a filter or a screen) and functions as a sieve. The drum portion 61 allows fibers or particles that are smaller than a mesh opening (opening) of the net through the mesh of the net and to be dropped from the drum portion 61. For example, a configuration of the drum portion 61 is the same as the configuration of the drum portion 41.

The “sieve” of the drum portion 61 may not have a function of sorting a specific target object. In other words, the “sieve” used as the drum portion 61 means a member having a net, and the drum portion 61 may allow the entire mixture introduced to the drum portion 61 to be dropped.

The second web former 70 is disposed below the drum portion 61. The second web former 70 accumulates passing substances having passed through the accumulation unit 60, and a second web W2 is formed. For example, the second web former 70 includes a mesh belt 72, a stretching roller 74, and a suction mechanism 76.

The mesh belt 72 is an endless belt, is suspended on a plurality of rollers 74, and is conveyed along with motion of the rollers 74 in a direction represented by an arrow in the drawing. For example, the mesh belt 72 is made of metal, resin, fabric, or nonwoven fabric. The mesh belt 72 has a surface configured of a net in which openings having a predetermined size are arranged. Among the first fibers or particles dropping from the drum portion 61, fine particles having a size to the extent that it is possible to pass through the mesh of the net fall downward from the mesh belt 72, and fibers having a size to the extent that it is not possible to pass through the mesh of the net are accumulated on the mesh belt 72 and are conveyed along with the mesh belt 72 in an arrow direction. The mesh belt 72 moves at a constant speed V2 at the time of a normal operation of manufacturing the sheet S. The time of the normal operation has a meaning as described above.

The mesh belt 72 has minute meshes of the net, and the mesh can have a size so as not to allow most of the fibers or particles dropping from the drum portion 61 to pass through the mesh belt.

The suction mechanism 76 is provided below the mesh belt 72 (on a side opposite to a side of the accumulation unit 60). The suction mechanism 76 includes a suction blower 77, and thus it is possible to generate an air flow (air flow toward the mesh belt 72 from the accumulation unit 60) toward below the suction mechanism 76 with a suction force of the suction blower 77.

The suction mechanism 76 suctions mixtures dispersed in the air by the accumulation unit 60 to the mesh belt 72. Consequently, it is possible to promote forming of the second web W2 on the mesh belt 72 and to increase a discharge speed from the accumulation unit 60. Further, the suction mechanism 76 is capable of forming a down flow in a falling route of the mixture and preventing the defibrated substances and the additive from being intertwined during falling.

The suction blower 77 (accumulating suction unit) may discharge air suctioned from the suction mechanism 76 to the outside of the sheet manufacturing apparatus 100 through a trapping filter (not illustrated). Alternatively, the air suctioned by the suction blower 77 may be sent into the dust collecting unit 27, and the substance to be removed, which is contained in the air suctioned by the suction mechanism 76, may be trapped.

The humidified air generated by the humidifying unit 208 is supplied to a space including the drum portion 61. It is possible to humidify an inside of the accumulation unit 60 with the humidified air, and thus it is possible to suppress the fibers or the particles from being attached to the housing portion 63 due to the electrostatic force, to drop the fibers and the particles rapidly to the mesh belt 72, and to form the second web W2 into a preferable shape.

As described above, through the accumulation unit 60 and the second web former 70 (a web forming step), the second web W2 is formed in a state of containing a large amount of air and being soft and expanded. The second web W2 accumulated on the mesh belt 72 is conveyed to the sheet former 80.

In a conveyance route of the mesh belt 72, the humidifying unit 212 supplies air containing mist to a downstream side of the accumulation unit 60. Consequently, the mist which is generated by the humidifying unit 212 is supplied to the second web W2, and an amount of moisture contained in the second web W2 is adjusted. Consequently, it is possible to suppress attachment or the like of a fiber to the mesh belt 72 due to the static electricity.

The sheet manufacturing apparatus 100 includes the conveying unit 79 that is provided to convey the second web W2 on the mesh belt 72 to the sheet former 80. For example, the conveying unit 79 includes a mesh belt 79a, a roller 79b, and a suction mechanism 79c.

The suction mechanism 79c has a blower (not illustrated) and generates an upward air flow from the mesh belt 79a with a suction force of a blower. The second web W2 is suctioned along with the air flow, and the second web W2 is separated from the mesh belt 72 so as to be attached to the mesh belt 79a. The mesh belt 79a moves along with rotation of the roller 79b and conveys the second web W2 to the sheet former 80. For example, a movement speed of the mesh belt 72 is the same as a movement speed of the mesh belt 79a.

In this manner, the conveying unit 79 peels the second web W2 formed on the mesh belt 72 from the mesh belt 72 so as to transport the second web.

The sheet former 80 forms the sheet S from the accumulated object accumulated by the accumulation unit 60. More specifically, the sheet former 80 pressurizes and heats the second web W2 (accumulated object) accumulated on the mesh belt 72 and conveyed by the conveying unit 79 so as to form the sheet S. In the sheet former 80, fibers of a defibrated substance and an additive which are contained in the second web W2 are heated, and thereby a plurality of fibers in a mixture are bound to each other via the additive (resin).

The sheet former 80 has a pressurizing unit 82 that pressurizes the second web W2 and a heating unit 84 that heats the second web W2 pressurized by the pressurizing unit 82.

The pressurizing unit 82 is configured of a pair of calendar rollers 85 (roller) and nips and pressurizes the second web W2 with a predetermined nip pressure. The second web W2 decreases in thickness by being pressurized, and density of the second web W2 increases. One of the pair of calendar rollers 85 is a drive roller that is driven by the pressurizing unit driving motor, and the other roller is a driven roller. The calendar roller 85 rotates by a drive force of the pressurizing unit driving motor so as to convey the second web W2 having high density due to pressurization toward the heating unit 84.

For example, the heating unit 84 can be configured to use a heating roller (heater roller), a thermal press forming device, a hot plate, a hot air blower, an infrared heater, or a flash fixing device. In the embodiment, the heating unit 84 has a pair of heating rollers 86. The heating rollers 86 are warmed to a preset temperature by a heater that is installed inside or outside. The heating rollers 86 nips the second web W2 pressurized by the calendar roller 85 so as to apply heat to the second web, and the sheet S is formed.

One of the pair of heating rollers 86 is a drive roller that is driven by a motor (not illustrated), and the other roller is a driven roller. The heating roller 86 rotates by a drive force of the motor so as to convey the heated sheet S toward the cutter 90.

As described above, the second web W2 formed by the accumulation unit 60 is pressed and heated by the sheet former 80 to form the sheet S.

The number of the calendar rollers 85 included in the pressurizing unit 82 and the number of the heating rollers 86 included in the heating unit 84 are not particularly limited.

The cutter 90 cuts the sheet S formed by the sheet former 80. In the embodiment, the cutter 90 includes a first cutter 92 that cuts the sheet S in a direction intersecting a conveyance direction of the sheet S and a second cutter 94 that cuts the sheet S in a direction parallel to the conveyance direction. For example, the second cutter 94 cuts the sheet S having passed through the first cutter 92.

As described above, a single sheet S having a predetermined size is formed. The cut single sheet S is discharged to a discharge unit 96. The discharge unit 96 includes a tray or a stacker on which the sheet S having a predetermined size is placed.

In the above-described configuration, the humidifying units 202, 204, 206, and 208 may be configured to be one vaporization-type humidifier. In this case, a configuration may be employed, in which humidified air generated by one humidifier diverges to be supplied to the rough crushing unit 12, the housing portion 43, the pipe 7, and the housing portion 63. In the configuration, a duct (not illustrated), through which the humidified air is supplied, is installed to diverge, and thereby it is possible to easily realize supply of the humidified air. In addition, it is needless to say that the humidifying units 202, 204, 206, and 208 can be each configured of two or three vaporization-type humidifiers.

In addition, in the above-described configuration, the humidifying units 210 and 212 may be configured of one ultrasound type humidifier or may be configured of two ultrasound type humidifier. For example, it is possible to employ a configuration in which air containing mist generated by one humidifier diverges to be supplied to the humidifying unit 210 and the humidifying unit 212.

In addition, in the above-described configuration, the rough crushing unit 12 first roughly crushes the raw material, and the sheet S is manufactured from the roughly crushed raw material; however, it is also possible to employ a configuration in which the sheet S is manufactured by using the fibers as the raw material.

For example, a configuration may be employed, in which it is possible to feed, as the raw material, fibers equivalent to the defibrated substances subjected to the defibrating process by the defibration unit 20, to the drum portion 41. In addition, a configuration may be employed, in which it is possible to feed, as the raw material, fibers equivalent to the first sorted substances separated from the defibrated substances to the pipe 54. In this case, fibers obtained by processing used paper, pulp, or the like are supplied to the sheet manufacturing apparatus 100, and thereby it is possible to manufacture the sheet S.

### 2.2. Fiber Aggregation Inhibitor Supply Unit

As illustrated in FIG. 2, the sheet manufacturing apparatus 100 further includes a fiber aggregation inhibitor supply unit 120 that supplies a fiber aggregation inhibitor.

The fiber aggregation inhibitor supply unit 120 is connected to, for example, a fiber aggregation inhibitor cartridge (not illustrated) that accumulates the fiber aggregation inhibitor, and supplies the fiber aggregation inhibitor inside the fiber aggregation inhibitor cartridge to the sorting unit 40. The fiber aggregation inhibitor cartridge may be configured to be removable from the fiber aggregation inhibitor supply unit 120. In addition, the fiber aggregation inhibitor cartridge may be configured to supplement with a fiber aggregation inhibitor. The fiber aggregation inhibitor supply unit 120 temporarily stores an additive formed of fine powder or particles inside the fiber aggregation inhibitor cartridge. In the illustrated example, the fiber aggregation inhibitor supply unit 120 supplies the fiber aggregation inhibitor once stored to the sorting unit 40 via the pipe 122. The pipe 122 is connected to the housing portion 43 of the sorting unit 40.

In the sheet S, the fiber aggregation inhibitor supply unit 120 supplies the fiber aggregation inhibitor such that a content of the fiber aggregation inhibitor becomes, for example, 5 parts or more and less than 25 parts, preferably 10 parts or more and less than 20 parts relative to 100 parts of fibers. The fiber aggregation inhibitor supply unit 120 includes, for example, a screw feeder, a circle feeder (not illustrated), and the like. The controller 110 may control the number of rotations of the screw feeder or the circle feeder of the fiber aggregation inhibitor supply unit 120 such that the content of the fiber aggregation inhibitor in the sheet S is in the above range.

The fiber aggregation inhibitor supply unit 120 supplies, for example, a fiber aggregation inhibitor having an average particle diameter smaller than the average length of fibers. The fiber aggregation inhibitor supply unit 120 includes, for example, a filter (not illustrated). The filter has, for example, a mesh having an opening of 30 μm, by which the fiber aggregation inhibitor supply unit 120 can supply a fiber aggregation inhibitor whose average particle diameter is smaller than the average length of fibers.

The sorting unit 40 is a first mixer that mixes a defibrated substance (the defibrated substance containing a fiber) defibrated by the defibration unit 20 with the fiber aggregation inhibitor supplied from the fiber aggregation inhibitor supply unit 120 to form a complex (the complex having the fiber and the fiber aggregation inhibitor integrally) having the defibrated substance and the fiber aggregation inhibitor integrally. The complex formed in the sorting unit 40 is conveyed to the mixer 50 through the first web former 45.

The mixer 50 is a second mixer that mixes the complex and a binding material containing a resin. In the sorting unit 40, in a case where there is a fiber aggregation inhibitor which is not disposed in the defibrated substance, the complex having the defibrated substance and the fiber aggregation inhibitor integrally may be formed by disposing the fiber aggregation inhibitor to the defibrated substance in the mixer 50. The mixture containing the complex and the binding material mixed in the mixer 50 is conveyed to the accumulation unit 60.

The accumulation unit 60 accumulates a mixture containing the complex and the binding material on the mesh belt 72 of the second web former 70. The accumulation unit 60 appropriately loosens the entangled fibers (specifically, the entangled complex) and the entangled resin, and allows them to fall down while being dispersed in the air. The upper limit of the opening of the accumulation unit 60 is 5 mm. By setting the size of the opening to 5 mm or less, it is possible to moderately loosen and allow the complex to pass, without passing through a large lump which is heavily intertwined with each other. Furthermore, even if there is a large entangled large lump-like complex or resin when mixed in the mixer 50, it can be appropriately loosened and passed through the accumulation unit 60. In the sorting unit 40 and the mixer 50, in a case where there is a fiber aggregation inhibitor which is not disposed in the defibrated substance, the complex having the defibrated substance and the fiber aggregation inhibitor integrally may be formed by disposing the fiber aggregation inhibitor to the defibrated substance in the accumulation unit 60.

Since the complex has the fiber and the fiber aggregation inhibitor integrally, even if they are intertwined before being conveyed to the accumulation unit 60, the second web W2 having high uniformity of fiber distribution can be formed by loosening in the accumulation unit 60. Furthermore, since the complex has fibers and a fiber aggregation inhibitor integrally, it is possible to reduce the possibility of the formation of a heavily entangled large clump-like complex when mixed in the mixer 50. Furthermore, the possibility of formation of a heavily entangled large clump-like complex when mixed in the sorting unit 40 can be reduced.

The second web W2 accumulated in the accumulation unit 60 is conveyed to the sheet former 80 via the conveying unit 79. The sheet former 80 heats and presses the second web W2 (the accumulated object) accumulated by the accumulation unit 60 to form the sheet S.

The second web W2 has a first surface (lower surface in FIG. 2) A1 in contact with the mesh belt 72 of the second web former 70, and a second surface (upper surface in FIG. 2) A2 in contact with the mesh belt 79a of the conveying unit 79. The second surface A2 is a surface opposite to the first surface A1. When the second web W2 is conveyed from the second web former 70 to the sheet former 80 via the conveying unit 79, first, the first surface A1 of the second web W2 separates from the mesh belt 72, and next, the second surface A2 of the second web W2 is separated from the mesh belt 79a, and the second web W2 is conveyed to the sheet former 80.

When the first surface A1 separates from the mesh belt 72, a part of the fiber aggregation inhibitor on the first surface A1 remains on the mesh belt 72. The mass of the fiber aggregation inhibitor remaining on the mesh belt 72 is, for example, 20% to 50% of the mass of the fiber aggregation inhibitor forming the first surface A1. In addition, when the second surface A2 is separated from the mesh belt 79a, a part of the fiber aggregation inhibitor on the second surface A2 remains on the mesh belt 79a. The mass of the fiber aggregation inhibitor remaining on the mesh belt 79a is, for example, 20% to 50% of the mass of the fiber aggregation inhibitor forming the second surface A2.

As described above, since, a part of the fiber aggregation inhibitor that forms the surfaces A1 and A2 remains on the mesh belts 72 and 79a, in the sheet S, the abundance ratio of the fiber aggregation inhibitor is greater at the inside than at least one of the surfaces A1 and A2. In the illustrated example, the abundance ratio of the fiber aggregation inhibitor is larger at the inside than at both surfaces A1 and A2. Although not illustrated, in a case where the second web W2 is conveyed to the sheet former 80 without using the conveying unit 79, in the sheet S, the abundance ratio of the fiber aggregation inhibitor is larger in the inner side than in one of the two surfaces (first surface A1).

The sheet manufacturing apparatus 100 includes the sorting unit 40 that mixes the defibrated substance defibrated by the defibration unit 20 with the fiber aggregation inhibitor to form a complex having the defibrated substance and the fiber aggregation inhibitor integrally. Therefore, in the sheet manufacturing apparatus 100, a sheet with inhibited fiber aggregation and high uniformity of fiber distribution can be manufactured.

### 3. Modification Example of Sheet Manufacturing Apparatus

### 3.1. First Modification Example

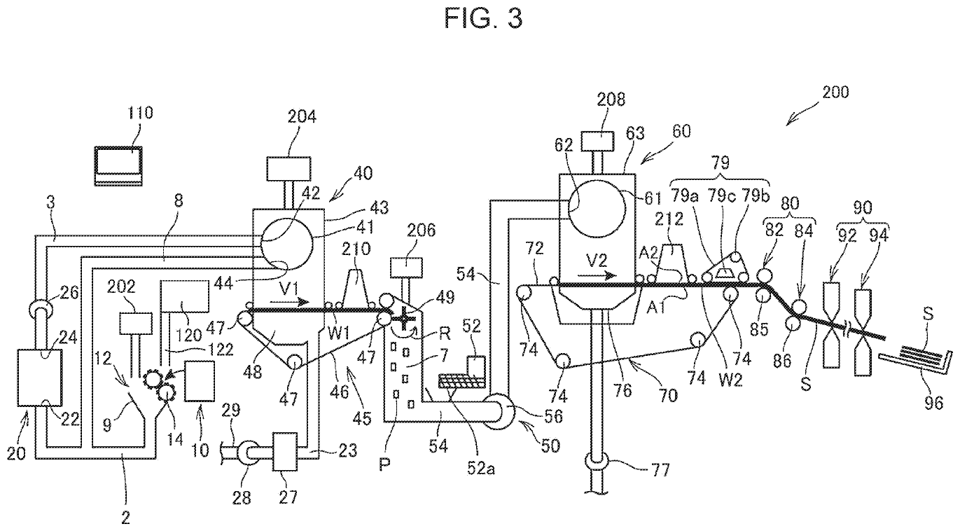

Next, a sheet manufacturing apparatus according to a first modification example of the present embodiment will be described with reference to the drawings. FIG. 3 is a view schematically illustrating a sheet manufacturing apparatus 200 according to the present embodiment.

Hereinafter, in the sheet manufacturing apparatus 200 according to the first modification example of the present embodiment, members having the same functions as the constituent members of the sheet manufacturing apparatus 100 according to the present embodiment described above are given the same reference numerals, and the detailed description thereof is omitted. The same applies to a sheet manufacturing apparatus according to a second modification example of the present embodiment described below.

In the sheet manufacturing apparatus 100 described above, as illustrated in FIG. 2, the fiber aggregation inhibitor supply unit 120 supplies the fiber aggregation inhibitor to the sorting unit 40. On the other hand, in the sheet manufacturing apparatus 200, as illustrated in FIG. 3, the fiber aggregation inhibitor supply unit 120 supplies the fiber aggregation inhibitor to the rough crushing unit 12 that cuts the raw material into small pieces. The defibration unit 20 defibrates the small pieces. In the illustrated example, the fiber aggregation inhibitor supply unit 120 supplies a fiber aggregation inhibitor toward the rough crushing blade 14 of the rough crushing unit 12. Although not illustrated, the fiber aggregation inhibitor supply unit 120 may supply a fiber aggregation inhibitor toward the chute 9 of the rough crushing unit 12 instead of the rough crushing blade 14. In this case, the fiber aggregation inhibitor does not pass through the rough crushing blade 14.

The fiber aggregation inhibitor supplied to the rough crushing unit 12 is conveyed to the defibration unit 20. The fiber aggregation inhibitor that has passed through the defibration unit 20 is conveyed from the defibration unit 20 to the sorting unit 40 by the air flow generated by the defibration unit 20. By the air flow generated by the defibration unit 20, the defibrated substance and the fiber aggregation inhibitor are mixed to form a complex having the defibrated substance and the fiber aggregation inhibitor integrally. In this case, the defibration unit 20 may also serve as a first mixer that forms a complex.

Furthermore, in the illustrated example, the fiber aggregation inhibitor that has passed through the defibration unit 20 is conveyed from the defibration unit 20 to the sorting unit 40 by the air flow generated by the defibration unit blower 26. The defibrated substance and the fiber aggregation inhibitor are mixed by the air flow generated by the defibration unit blower 26, and a complex having the defibrated substance and the fiber aggregation inhibitor integrated is formed. In this case, the defibration unit blower 26 may be a first mixer that forms a complex.

In the sheet manufacturing apparatus 200, the same effect as that of the sheet manufacturing apparatus 100 can be obtained.

In the sheet manufacturing apparatus 200, the fiber aggregation inhibitor supply unit 120 supplies the fiber aggregation inhibitor to the rough crushing unit 12. Therefore, in the sheet manufacturing apparatus 200, for example, in the pipe 3 for connecting a portion to which the defibration unit 20 and the defibrated substance are conveyed next (the sorting unit 40 in the illustrated example), the complex having the defibrated substance and the defibrated substance integrally cab be formed. Therefore, in the sheet manufacturing apparatus 200, it is possible to suppress that the fibers are aggregated in the pipe 3 to form lumps and the pipe 3 is clogged.

### 3.2. Second Modification Example

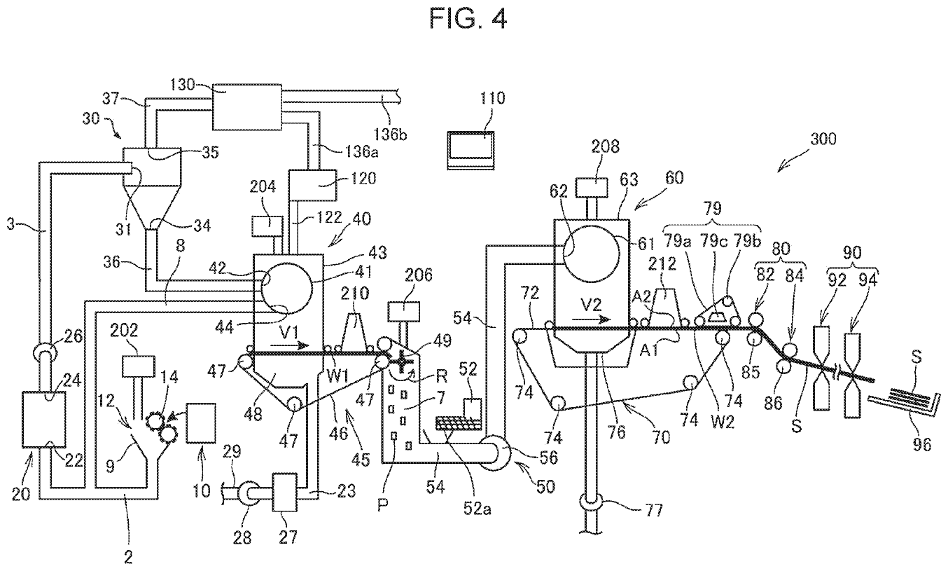

Next, a sheet manufacturing apparatus according to a second modification example of the present embodiment will be described with reference to the drawings. FIG. 4 is a view schematically illustrating a sheet manufacturing apparatus 300 according to the present embodiment.

The sheet manufacturing apparatus 300 is different from the above-described sheet manufacturing apparatus 100 in that the sheet manufacturing apparatus 300 includes a classifying unit 30, as illustrated in FIG. 4. In the sheet manufacturing apparatus 300, the defibrated substance defibrated in the defibration unit 20 is conveyed to the classifying unit 30 via the pipe 3.

The classifying unit 30 separates the defibrated substance and the fiber aggregation inhibitor. An air flow classifier is used as the classifying unit 30. The air flow classifier generates swirling air flow and separates the swirling air flow according to centrifugal force and the size and density of the material to be classified, and a classification point can be adjusted by adjusting the speed and centrifugal force of the air flow. Specifically, a cyclone, an elbow jet, an eddy classifier, or the like is used as the classifying unit 30. In particular, a cyclone can be suitably used as the classifying unit 30 because the structure is simple. Below, the case where a cyclone is used as the classifying unit 30 will be described.

The classifying unit 30 includes for example, an introduction port 31, a lower discharge port 34 provided in the lower portion, and an upper discharge port 35 provided in the upper portion. In the classifying unit 30, the air flow loaded with the defibrated substance introduced from the introduction port 31 is moved circumferentially, and thereby, the introduced defibrated substance is separated by a centrifugal force into a first classified matter (disassembled fiber) and a second classified matter (for example, the fiber aggregation inhibitor and the colorant) which is smaller than the first fraction and has a lower density. In the sheet manufacturing apparatus 300, since the raw material is waste paper, the raw material contains a fiber aggregation inhibitor and a coloring agent. The first classified matter is used as a raw material of the sheet S, and is conveyed to the sorting unit 40 via the pipe 36. On the other hand, the second classified matter is conveyed to the fiber aggregation inhibitor separation unit 130 via the pipe 37.

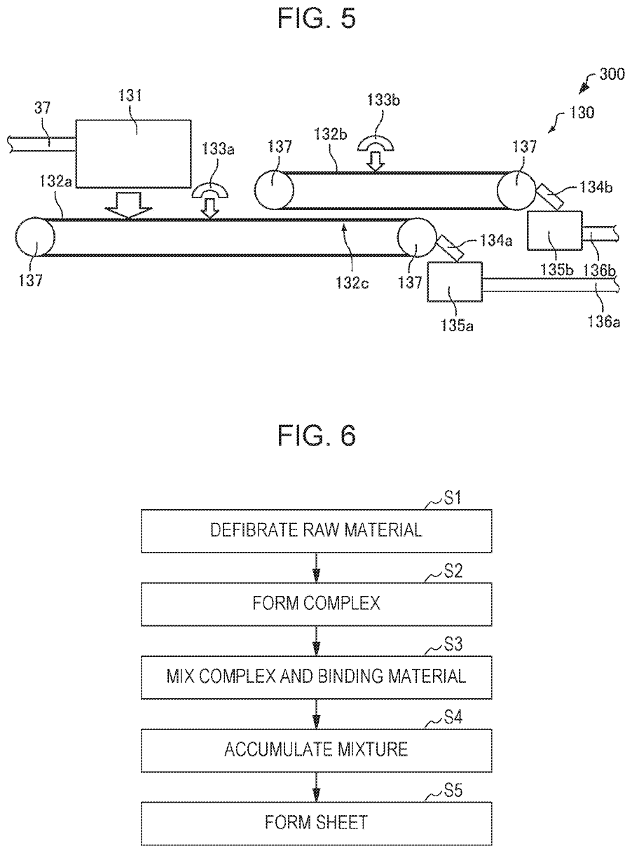

The fiber aggregation inhibitor separation unit 130 can separate the fiber aggregation inhibitor and the coloring agent contained in the second classified matter. Here, FIG. 5 is a view schematically showing the fiber aggregation inhibitor separation unit 130. As illustrated in FIG. 5, the fiber aggregation inhibitor separation unit 130 includes a buffer unit 131, conveying belts 132a and 132b, charging units 133a and 133b, blades 134a and 134b, trapping units 135a and 135b, and pipes 136a and 136b.

The second classified matter conveyed to the fiber aggregation inhibitor separation unit 130 is accumulated in the buffer unit 131. The buffer unit 131 drops the accumulated second classified material toward the first conveying belt 132a.

The first conveying belt 132a accumulates and conveys the second classified matter. The conveying belts 132a and 132b are movable by rotation of the roller 137. The first charging unit 133a collectively charges the second classified matter on the conveying belt 132a negatively. Hence, the colorant has a strong negative charge, and the fiber aggregation inhibitor has a weaker negative charge than the colorant.

The second conveying belt 132b is provided to overlap with the first conveying belt 132a in an overlapping unit (overlap area) 132c. The second conveying belt 132b is positively charged by the second charging unit 133b. The charging units 133a and 133b are, for example, scorotron chargers.

Since the colorant conveyed by the first conveying belt 132a has strong negative charge, the colorant is moved to the second conveying belt 132b at the overlapping unit 132c of the conveying belts 132a and 132b. On the other hand, since the fiber aggregation inhibitor has weak negative charge, the fiber aggregation inhibitor is not moved to the second conveying belt 132b.

The fiber aggregation inhibitor conveyed by the first conveying belt 132a is scraped off by the first blade 134a and accommodated in the first trapping unit 135a. The fiber aggregation inhibitor contained in the first trapping unit 135a is conveyed to the fiber aggregation inhibitor supply unit 120 via the pipe 136a. The fiber aggregation inhibitor supply unit 120 supplies a fiber aggregation inhibitor (a fiber aggregation inhibitor separated by the classifying unit 30) to the sorting unit 40.

On the other hand, the colorant conveyed by the second conveying belt 132b is scraped off by the second blade 134b and accommodated in the second trapping unit 135b. The colorant accommodated in the second trapping unit 135b is conveyed, for example, to the outside through the pipe 136b. The colorant conveyed to the outside may be reused.

As described above, the fiber aggregation inhibitor separation unit 130 can separate the fiber aggregation inhibitor and the colorant.

In the sheet manufacturing apparatus 300, the same effect as the sheet manufacturing apparatus 100 can be obtained.

In the sheet manufacturing apparatus 300 includes the classifying unit 30 that separates the defibrated substance and the fiber aggregation inhibitor, and the fiber aggregation inhibitor supply unit 120 that supplies the fiber aggregation inhibitor separated by the classifying unit 30 to the sorting unit 40, and the raw material is used paper. Therefore, in the sheet manufacturing apparatus 300, the fiber aggregation inhibitor contained in the used paper can be reused. Therefore, in the sheet manufacturing apparatus 300, cost reduction can be achieved.

When the second classified material contains an additive other than the fiber aggregation inhibitor and the colorant, after separating the fiber aggregation inhibitor and the additive and the coloring agent using the difference between the chargeability by using the fiber aggregation inhibitor separation unit 130 as described above, and then, the fiber aggregation inhibitor and the additive may be separated by using the same separation unit as the fiber aggregation inhibitor separation unit 130 and using the difference in chargeability between the fiber aggregation inhibitor and the additive.

Further, although not illustrated, in the sheet manufacturing apparatus 300, the fiber aggregation inhibitor supply unit 120 may supply the fiber aggregation inhibitor separated by the classifying unit 30 to the rough crushing unit 12 as the sheet manufacturing apparatus 200 described above.

### 4. Sheet Manufacturing Method

Next, the sheet method according to the present embodiment will be described with reference to the drawings. FIG. 6 is a flowchart for illustrating a sheet manufacturing method of the present embodiment. The sheet manufacturing method which concerns on this embodiment is performed using the sheet manufacturing apparatus (for example, sheet manufacturing apparatus 100) according to the present invention.

In the sheet manufacturing method according to the present embodiment, as illustrated in FIG. 6, a process of defibrating a raw material containing a fiber (step S1), a process of mixing the defibrated substance which is defibrated and the fiber aggregation inhibitor to form a complex having the defibrated substance and the fiber aggregation inhibitor integrally (step S2), a process of mixing the complex and a binding material containing a resin (step S3), a process of accumulating a mixture containing the complex and the binding material (step S4), and a process of heating and pressing the accumulated object which is accumulated to form a sheet (step S5).

The details of the above process are as described in the above-mentioned “2. Sheet Manufacturing Apparatus”. Therefore, the detailed description is omitted.

In the sheet manufacturing method according to the present embodiment, a sheet with inhibited fiber aggregation and high uniformity of fiber distribution can be manufactured.

### 5. Experimental Example

The present invention will be described more specifically by showing experimental examples below. The present invention is not limited at all by the following experimental examples.

### 5.1. First Experimental Example

### 5.1.1. Experimental Condition

The content of the fiber aggregation inhibitor was changed, and a sheet was manufactured using a manufacturing apparatus such as the sheet manufacturing apparatus 100. In the manufactured sheet, the content of the fiber aggregation inhibitor is changed such that the content of the fiber aggregation inhibitor is less than 5 parts, 5 parts or more and less than 10 parts, 10 parts or more and less than 20 parts, 20 parts or more and less than 25 parts, and 25 parts or more relative to the 100 parts of the fiber. The carbonate was used as a fiber aggregation inhibitor. A4 size (210 mm×297 mm) sheets were produced.

The above-described sheet was printed using an inkjet printer (“PX-G930” manufactured by Seiko Epson Corporation). Printing was performed with 50% solid (solid density 50%) at a resolution of 360×360 dpi and an ink ejection speed of 25 mg/s. For the printing, a dye ink (“KUI-C” manufactured by Seiko Epson Corporation) and a pigment ink (“ICC 93L” manufactured by Seiko Epson Corporation) were used.

### 5.1.2. Experimental Result

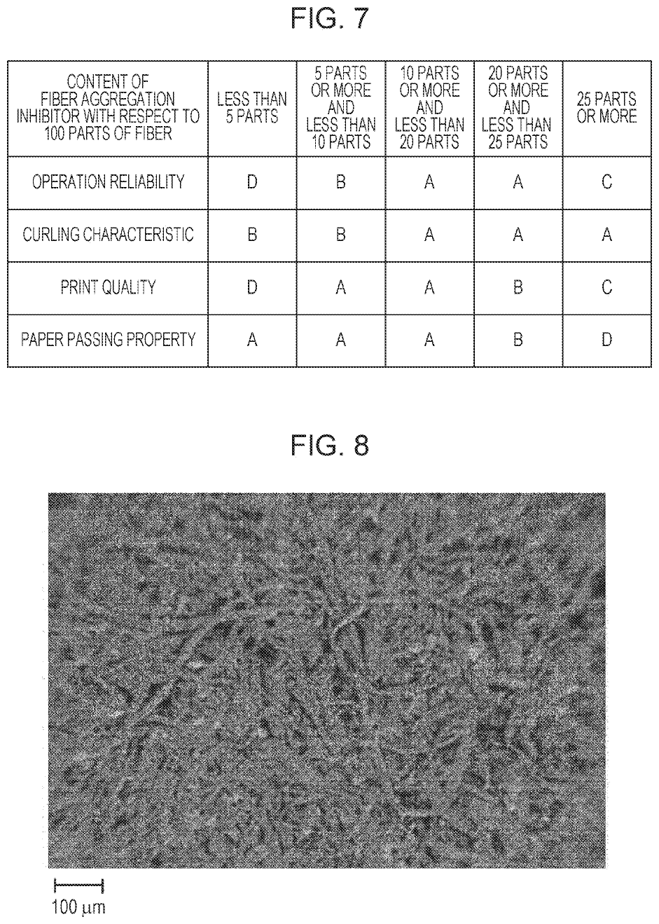

FIG. 7 is a table illustrating experimental results, and more specifically, is a table illustrating operation reliability, curling characteristics, print quality, and paper feedability. In addition, operation reliability and paper passing property experimented on the sheet before printing with an inkjet printer. The curling characteristics and the print quality were tested on a sheet after printing with an ink jet printer.

### (1) Operation Reliability

In the sheet manufacturing apparatus used in this experiment, the operation reliability is represented by the number of times of occurrence of pressure fluctuation of the conveying air flow due to clogging of the device due to adhesion and flocculation between fibers, entanglement due to crimp, lumps and the like (number of times for 60 minutes of operation) and the number of occurrences of abnormality of the apparatus operation (number of times for 60 minutes of operation).

In FIG. 7, the operation reliability is ranked as A to D in the following contents as the number of occurrences of pressure fluctuation of the conveying air flow and the number of occurrences of abnormality of the apparatus operation.

A: Minor pressure fluctuation 0 times and abnormality of apparatus operation error 0 times

B: Minor pressure fluctuation 1 time and abnormality of apparatus operation 0 times

C: Severe pressure fluctuation 1 to 3 times and abnormality of apparatus operation 1 time or more

D: Severe pressure fluctuation 4 times or more and abnormality of apparatus operation 1 time or more

As shown in FIG. 7, when the content of the fiber aggregation inhibitor is less than 5 parts, the fiber aggregation inhibitor is insufficient, adhesion between the fibers, aggregation, fuzzing, and entanglement due to crimp causes many clumps, and the abnormality occurs remarkably and thus, the operation reliability was ranked as “D”. When the content of the fiber aggregation inhibitor is 5 parts or more and less than 10 parts, the effect of fiber dispersion appears and the number of anomalies is reduced, and the operation reliability was ranked as “B”. When the content of the fiber aggregation inhibitor is 10 parts or more and less than 25 parts, the operation reliability was ranked as “A”. When the content of the fiber aggregation inhibitor is 25 parts or more, the fiber aggregation inhibitor is supplied too much and clogging of the apparatus according to the fine powder is increased, and thus the operation reliability was ranked as “C”.

### (2) Curling Characteristics

The curling characteristics are represented by the amount of sheet curling (the difference between the height of the highest portion and the height of the lowest portion of the sheet) within 60 seconds after being discharged from the ink jet printer. The curling characteristics depend on the uniformity of the fibers in the in-plane direction. If the uniformity of the fibers in the in-plane direction is high, the uniformity of the humidity expansion coefficient in the in-plane direction is high, and the curling amount is small. The amount of curling was measured by a micrometer.

In FIG. 7, the curling characteristics are ranked as A to D with the following contents, with the amount of curling.

A: less than 10 mm

B: 10 mm or more and less than 20 mm

C: 20 mm or more and less than 30 mm

D: 30 mm or more

As shown in FIG. 7, when the content of the fiber aggregation inhibitor is less than 10 parts, the curling characteristics are ranked as “B”. However, when the content of the fiber aggregation inhibitor is 10 parts or more, the uniformity of the fibers in the in-plane direction was improved, and thus, the curling characteristics were ranked as “A”. The rank in curling characteristics did not change for dye and pigment inks.

### (3) Print Quality

Print quality is expressed as the degree of whiskers of the ink (like the whiskers that occur as the ink travels along the fibers) and bleed. The print quality depends on the porosity of the sheet. When the deviation of the sheet gap is suppressed, the ink absorption amount and absorption speed becomes uniformly, and good print quality with less whiskers and wrinkles of the ink can be obtained.

In FIG. 7, the print quality is ranked as A to D in the following contents as the degree of the beard and the bleeding.

A: Almost not confirmed

B: Slightly confirmed

C: Confirmed

D: Remarkably confirmed

As shown in FIG. 7, when the content of the fiber aggregation inhibitor is less than 5 parts, since the fiber aggregation inhibitor is insufficient and the voids of the sheet are biased, the whiskers and bleeding are remarkably confirmed, and thus, the print quality was ranked as “D”. When the content of the fiber aggregation inhibitor is 5 parts or more and less than 20 parts, the void deviation of the sheet is suppressed, the print quality has improved sharply, and whiskers and bleeding are hardly confirmed, and thus, the print quality was ranked as “A”. When the content of the fiber aggregation inhibitor is 20 part or more and less than 25 parts, since the amount of the fiber aggregation inhibitor is large and the voids are filled, the print quality is degraded, and whiskers and bleeding are slightly confirmed, and thus, the print quality was ranked as “B”. When the content of the fiber aggregation inhibitor is 25 parts or more, whiskers and bleeding are confirmed, and thus, the print quality was ranked as “C”. The rank in print quality did not change for the dye ink and the pigment ink.

### (4) Paper Feedability

Paper feedability is represented by the number of the occurrences of jamming (clogging) in a case of passing the paper 1000 times through an ink jet printer (PX-G 930 manufactured by Seiko Epson Corporation) (in a case of passing a sheet from the feed tray to the discharge tray without printing). The fiber aggregation inhibitor can suppress clogging of the sheet manufacturing apparatus by suppressing adhesion and condensation of fibers, entanglement due to crimp, clumps and the like, as long as the fiber aggregation inhibitor is an appropriate amount. However, when the amount of the fiber aggregation inhibitor exceeds a suitable amount, the binding properties of the fibers are rapidly inhibited, and the rigidity, elasticity, and strength decrease of the sheet occur. Therefore, sheet feeding and conveyance defects frequently occur in the printer due to the bending rigidity of the sheet and the shortage of the sheet waist.

In FIG. 7, the paper feedability is regarded as the number of occurrences of jams and ranked as A to D in the following contents.

A: 0 times

B: 1 time

C: 2 times to 9 times

D: 10 times or more

As shown in FIG. 7, when the content of the fiber aggregation inhibitor is less than 20 parts, the rigidity and the strength of the sheet are maintained, and the conveyance of the printer can be tolerated, and thus, the paper feedability was ranked as “A”. When the content of the fiber aggregation inhibitor is 20 parts to 25 parts, the binding property of the fibers is inhibited and the rigidity, elasticity, and strength of the sheet are reduced. As a result, due to the bending stiffness of the sheet and the lack of stiffness of the sheet, feeding and conveyance defects occur in the printer, and thus, the paper feedability was ranked as “B”. When the content of the fiber aggregation inhibitor is 25 parts or more, the conveyance is rapidly deteriorated due to a decrease in the coefficient of friction due to excess powder, and thus, the paper feedability was ranked as “D”.

### 5.2 Second Experimental Example

The SEM observation of the sheet (sheet according to the example) manufactured by the manufacturing apparatus such as the sheet manufacturing apparatus 100 and the sheet (sheet according to the comparative example) manufactured by the wet method was performed. In the sheet according to the example, the content of the fiber aggregation inhibitor is 10 parts or more and less than 20 parts relative to 100 parts of fibers.

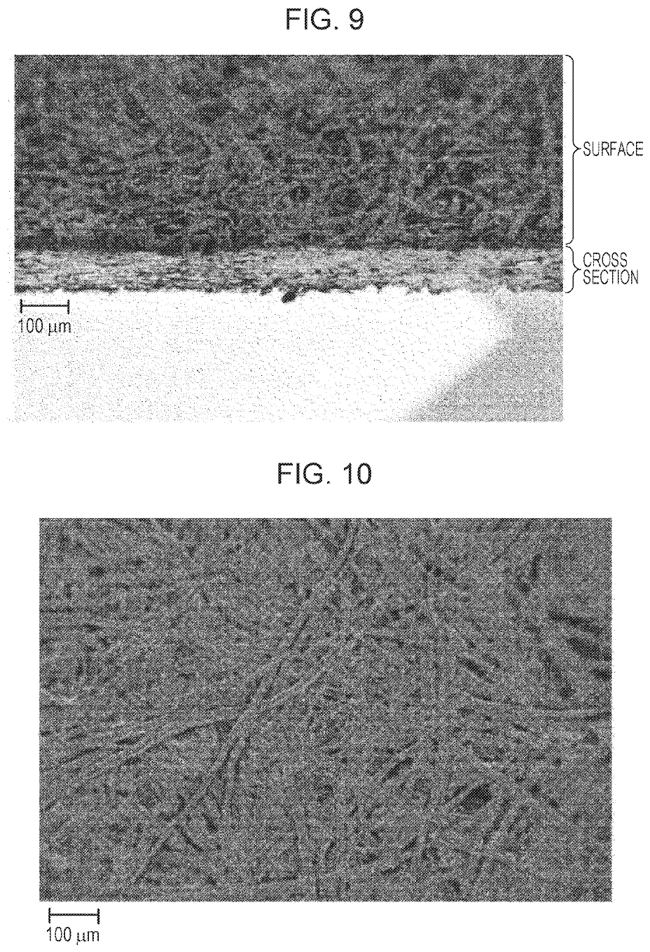

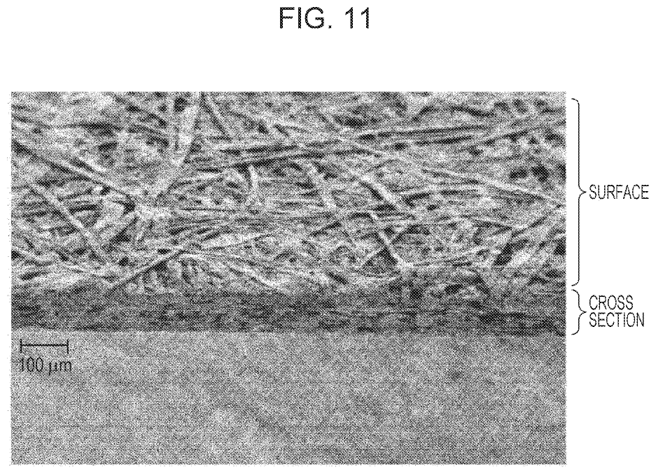

FIGS. 8 and 9 are SEM images of the sheet according to the example. FIGS. 10 and 11 are SEM images of a sheet according to a comparative example. In FIGS. 8 and 10, the surface of the sheet is observed, and in FIGS. 9 and 11, the surface and the cross section of the sheet are observed.

As shown in FIGS. 8 to 11, in the sheet according to the comparative example, it was confirmed that the fibers were substantially linear, and in the sheet according to the example, it was confirmed that the fibers (a moderately crimped fiber) bent appropriately.

The invention may be configured to omit some of the configurations described above insofar as the features and effects described above are retained, and may combine aspects of different embodiments and examples.

The invention includes configurations that are substantially the same as the configurations described in connection with the above embodiments (for example, in function, method and effect, or objective and effect). The invention also includes configurations that replace parts that are not essential to the configuration described in the foregoing embodiment. Furthermore, the invention includes configurations having the same operating effect, or configurations that can achieve the same objective, as configurations described in the foregoing embodiment. Furthermore, the invention includes configurations that add technology known from the literature to configurations described in the foregoing embodiment.

### REFERENCE SIGNS LIST

COMPLEX

1a FIBER

1b FIBER AGGREGATION INHIBITOR

2, 3, 7, 8 PIPE

9 CHUTE

10 SUPPLY UNIT

12 ROUGH CRUSHING UNIT

14 ROUGH CRUSHING BLADE

20 DEFIBRATION UNIT

22 INTRODUCTION PORT

23 PIPE

24 DISCHARGE PORT

26 DEFIBRATION UNIT BLOWER

27 DUST COLLECTING UNIT

28 TRAPPING BLOWER

29 PIPE

30 CLASSIFYING UNIT

31 INTRODUCTION PORT

34 LOWER DISCHARGE PORT

35 UPPER DISCHARGE PORT

36 PIPE

40 SORTING UNIT

41 DRUM PORTION

42 INTRODUCTION PORT

43 HOUSING PORTION

44 DISCHARGE PORT

45 FIRST WEB FORMER

46 MESH BELT

47 ROLLER

48 SUCTION UNIT

49 ROTARY BODY

50 MIXER

52 ADDITIVE SUPPLY UNIT

52a DISCHARGE UNIT

54 PIPE

56 MIXING BLOWER

60 ACCUMULATION UNIT

61 DRUM PORTION

62 INTRODUCTION PORT

63 HOUSING PORTION

70 SECOND WEB FORMER

72 MESH BELT

74 ROLLER

76 SUCTION MECHANISM

77 SUCTION BLOWER

79 CONVEYING UNIT

79a MESH BELT

79b ROLLER

79c SUCTION ROLLER

80 SHEET FORMER

82 PRESSURIZING UNIT

84 HEATING UNIT

85 CALENDAR ROLLER

86 HEATING ROLLER

90 CUTTER

92 FIRST CUTTER

94 SECOND CUTTER

96 DISCHARGE UNIT

100 SHEET MANUFACTURING APPARATUS

110 CONTROLLER

120 FIBER AGGREGATION INHIBITOR SUPPLY UNIT

122 PIPE

130 FIBER AGGREGATION INHIBITOR SEPARATION UNIT

131 BUFFER UNIT

132a FIRST CONVEYING BELT

132b SECOND CONVEYING BELT

132c OVERLAPPING UNIT

133a FIRST CHARGING UNIT

133b SECOND CHARGING UNIT

134a FIRST BLADE

134b SECOND BLADE

135a FIRST TRAPPING UNIT

135b SECOND TRAPPING UNIT

136a, 136b PIPE

137 ROLLER

200 SHEET MANUFACTURING APPARATUS

202, 204, 206, 208, 210, 212 HUMIDIFYING UNIT

300 SHEET MANUFACTURING APPARATUS

1. A sheet comprising:
a first complex having a fiber and a fiber aggregation inhibitor integrally;
a second complex having a fiber and a fiber aggregation inhibitor integrally; and
a binding material which combines the first complex and the second complex and contains a resin.

2. The sheet according to claim 1,
wherein the sheet has a first surface and a second surface opposite to the first surface, and
wherein the fiber aggregation inhibitor is included between the first surface and the second surface.

3. The sheet according to claim 1,
wherein the sheet has a first surface and a second surface opposite to the first surface,
wherein the fiber aggregation inhibitor is included between the first surface and the second surface, and
wherein an abundance ratio of the fiber aggregation inhibitor is greater between the first surface and the second surface than at least one of the first surface and the second surface.

4. The sheet according to claim 1,
wherein the fiber aggregation inhibitor contains at least one of calcium carbonate, clay, titanium dioxide, white carbon, kaolin, and talc.

5. The sheet according to claim 1,
wherein a content of the fiber aggregation inhibitor is 5 parts or more and less than 25 parts relative to 100 parts of the fiber.

6. The sheet according to claim 1,
wherein a content of the fiber aggregation inhibitor is 10 parts or more and less than 20 parts relative to 100 parts of the fiber.

7. A sheet manufacturing apparatus comprising:
a defibration unit that defibrates a raw material containing a fiber;
a first mixer that mixes a defibrated substance defibrated by the defibration unit with a fiber aggregation inhibitor to form a complex containing the defibrated substance and the fiber aggregation inhibitor integrally;
a second mixer that mixes the complex and a binding material containing a resin;
an accumulation unit that accumulates a mixture containing the complex and the binding material; and
a sheet former that forms a sheet by heating and pressing an accumulated object accumulated by the accumulation unit.

8. The sheet manufacturing apparatus according to claim 7, further comprising:
a rough crushing unit that cuts the raw material into small pieces; and
a supply unit that supplies the fiber aggregation inhibitor to the rough crushing unit,
wherein the defibration unit defibrates the small pieces.

9. The sheet manufacturing apparatus according to claim 7, further comprising:
a classifying unit that separates the defibrated substance and the fiber aggregation inhibitor; and
a supply unit that supplies the fiber aggregation inhibitor separated by the classifying unit to the first mixer,
wherein the raw material is used paper.

10. A sheet manufacturing method comprising:
defibrating a raw material containing a fiber;
mixing a defibrated substance which is defibrated with a fiber aggregation inhibitor to form a complex containing the defibrated substance and the fiber aggregation inhibitor integrally;
mixing the complex and a binding material containing a resin;
accumulating a mixture containing the complex and the binding material; and
forming a sheet by heating and pressing an accumulated object which is accumulated.
